(19) United States
(12) Patent Application Publication
(10) Pub. No.: US 2014/0152452 A1
(43) Pub. Date: Jun. 5, 2014

(54) Friendly Fire Hunting Safety Sensor

(71) Applicants: Wilburn Ray Whittington, Starkville, MS (US); Raj Prahbu, Starkville, MS (US); Shane Andrew Brauer, Starkville, MS (US)

(72) Inventors: Wilburn Ray Whittington, Starkville, MS (US); Raj Prahbu, Starkville, MS (US); Shane Andrew Brauer, Starkville, MS (US)

(21) Appl. No.: 13/705,333

(22) Filed: Dec. 5, 2012

(51) Int. Cl. G08B 21/02; G01S 3/14

(52) U.S. Cl. CPC G08B 21/02; G01S 3/14
USPC 340/686.1; 342/417

(57) ABSTRACT

An RF directional detection system created for alerting hunters of nearby friendlies who are located in critical areas defined by the ability to communicate their directional position to the hunters for safety purposes. These systems utilize a Yagi directional antenna to provide the radiation pattern necessary for directional detection.

### FIELD OF THE INVENTION

This invention relates generally to prevention of persons or property from unwanted or unnecessary events through radio (RF) based combat identification (IFF) systems, as well as hunting safety prevention.

### DESCRIPTION OF THE PRIOR ART

The present invention is related to U.S. Pat. No. 8,179,247 and U.S. patent application Ser. No. 12/022,982 which provides systems for detecting fellow hunters in danger zones.

The issues related to hunting accidents are not resolved by conventional methods. The current procedure for identification of other hunters in critical areas is provided by highly reflective or illuminated clothing worn by hunters. These solutions only work under high visibility conditions. For other environments where sight is limited, such as in heavy brush, fog, or loss of daylight, these methods provide little information about another hunter's presence.

U.S. Pat. No. 8,179,247 describes a solution to conventional means by providing a Ka band transmitter and detector which is directed by a horn antenna. The problem with this method is that components in the Ka band are relatively expensive to develop and mass produce as compared to similar operating components in lower frequencies. The inventors, however, have chosen this band due to the ease of directionality produced with compact horn antennas.

U.S. patent application Ser. No. 12/022,982 provides a solution which uses a lower frequency band than said U.S. Pat. No. 8,179,247 with the aid of infrared sensors. This logic of this design follows that infrared sensors are very directional and the RF sensors are not very directional. The invention then provides both packages into a signal system such that short and long range detection is possible. The drawback is that infrared sensors cannot penetrate through brush or animals and therefore can be prone to misinformation.

The instant invention presents an alternative to using coupled RF and infrared sensors and/or Ka band RF frequencies.

### SUMMARY OF THE INVENTION

The instant invention solves the problem of highly expensive components necessary to use RF only sensory in a directional detection system.

The system utilizes a Yagi antenna which can be scalable by the number of elements and geometry to provide the directionality needed for the specific hunting event. The RF energy radiated by the person or property of interest can be captured by the Yagi antenna and evaluated by a signal processor. The result can be outputted to an alarm which can warn the hunter of unwanted targets in the general direction of the firearm that he or she is pointing at.

### DRAWINGS

FIG. 1 illustrated the versatility of a Yagi antenna for providing directionality in the signal strength depending on the number of elements.

FIG. 2 shows the block diagram for capturing and evaluating the RF signal from a remote transmitter.

### DETAILED DESCRIPTION OF THE PREFERRED EMBODIMENTS OF THE INVENTION FRIENDLY FIRE HUNTING SAFETY SENSOR

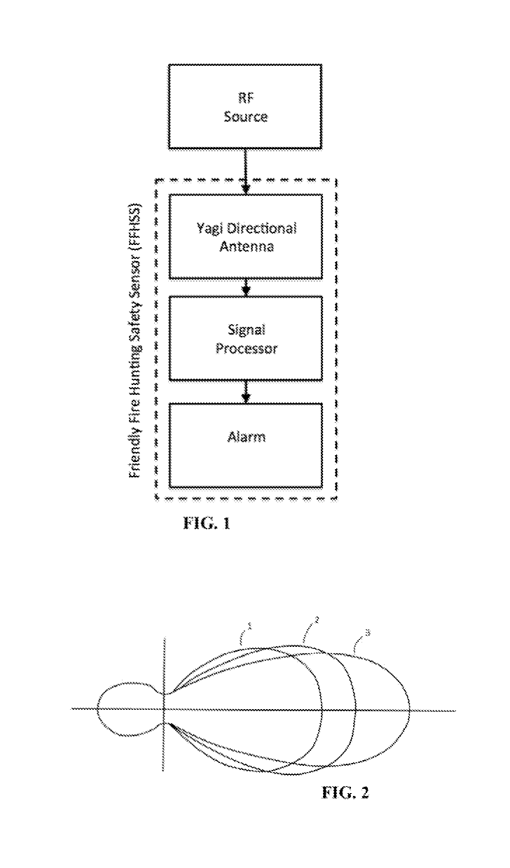

The block diagram for the sensor is illustrated in FIG. 1.

The system for alerting hunters of unwanted targets includes a Yagi RF antenna, a signal processing circuit, and an alarm which tells the hunter whether or not discharging the firearm is appropriate. FIG. 1 show that a transmitter must exist for the system to work appropriately, and therefore the transmitter must be with the target of interest and turned on. This transmitter can be common place transmitters such as cell phones, Bluetooth devices, or custom devices.

The Yagi antenna is necessary to provide the directional sensing necessary to inform the hunter of the directionality of the targets of interest. FIG. 2 shows an illustration of the radiation pattern for a Yagi antenna of two elements 1, three elements 2, or four elements 3. By selecting the number of elements for the specific need, the designer to the specific sensor can vary how wide or narrow the radiation pattern is. This allows usage of the system in long range or short range environments.

The RF signal processor, placed in the block diagram in FIG. 1, makes the determination as to whether or not the signal received is strong enough to warrant outputting a trigger to the alarm. This processing can be performed by filtering unwanted RF noise, amplifying the signal frequencies of interests, converting the RF signals to respective DC voltages, and selecting a voltage threshold for output triggering.

The alarm, shown as the final step to the block diagram in FIG. 1, can come in many forms. Typically, an LED light will turn on, allowing the hunter to notice that he is pointing in an inappropriate direction.

What is claimed is:

1. An RF system for alerting hunters of unwanted targets in the hunter's discharge direction comprising of a Yagi antenna which captures a transmitted signal from the target of interest, a signal processing circuit which evaluates the signal, and an alarm which is triggered from the signal processing circuit.

2. The use of a Yagi anteena to provide directional sensing of RF for the purpose of monitoring the relative direction between a RF transmitter and a firearm.
